(19) United States
(12) Patent Application Publication
(10) Pub. No.: US 2023/0160701 A1
(43) Pub. Date: May 25, 2023

(54) MAP PROCESSING SYSTEM AND NON-TRANSITORY COMPUTER-READABLE STORAGE MEDIUM HAVING MAP PROCESSING PROGRAM STORED THEREON

(71) Applicant: DENSO CORPORATION, Kariya-city (JP)

(72) Inventor: Masashi TSUKADAIRA, Kariya-city (JP)

(21) Appl. No.: 18/151,048

(22) Filed: Jan. 6, 2023

Related U.S. Application Data
(63) Continuation of application No. PCT/JP21/22687, filed on Jun. 15, 2021.

(30) Foreign Application Priority Data
Jul. 10, 2020 (JP) 2020-119192

(51) Int. Cl. G01C 21/32; G01C 21/00

(52) U.S. Cl. CPC G01C 21/32; G01C 21/3822; G01C 21/3841

(57) ABSTRACT

A map processing system includes a feature quantity calculating section configured to calculate a feature quantity of a feature point included in a map, an integrated feature point generating section configured to integrate a plurality of feature points to generate an integrated feature point, an integrated feature point matching section configured to match integrated feature points between a plurality of maps, a feature point matching section configured to match individual feature points between the plurality of maps, and a map processing section configured to process a map based on a matching result of the integrated feature points and a matching result of the individual feature points.

### CROSS-REFERENCE TO RELATED APPLICATION

The present application is a continuation application of International Application No. PCT/JP2021/022687, filed on Jun. 15, 2021, which claims priority to Japanese Patent Application No. 2020-119192, filed in Japan on Jul. 10, 2020. The contents of these applications are incorporated herein by reference in their entirety.

### BACKGROUND

### 1. Technical Field

The present disclosure relates to a map processing system.

### 2. Related Art

Map processing devices have been provided that acquire probe data from a vehicle side, generate an input map based on the acquired probe data, and generate an integrated input map by integrating multiple input maps or update a reference map by correcting the position of the input map. Specifically, such a map processing device generates, for example, multiple input maps including positional information of feature points such as landmarks, matches the feature points included in the generated input maps, and superimposes the input maps to generate an integrated input map. Alternatively, the position of the input map is corrected by superimposing the reference map on the input map while matching the feature points included in the reference map with the feature points included in the input map, and the difference between the reference map and the input map is reflected in the reference map to update the reference map. In generating the integrated input map or updating the reference map as described above, the accuracy of the input maps is desirably increased.

### SUMMARY

The present disclosure provides a map processing system for appropriately processing a map. As one aspect of the present disclosure, a map processing system includes at least a feature quantity calculating section, an integrated feature point generating section, an integrated feature point matching section, a feature point matching section, and map processing section. The feature quantity calculating section is configured to calculate a feature quantity of a feature point included in a map. The integrated feature point generating section is configured to integrate a plurality of feature points to generate an integrated feature point. When the integrated feature point is generated, the integrated feature point matching section is configured to match integrated feature points between a plurality of maps. The feature point matching section is configured to match individual feature points between the plurality of maps. The map processing section is configured to process a map based on a matching result of the integrated feature points and a matching result of the individual feature points.

### BRIEF DESCRIPTION OF THE DRAWINGS

In the accompanying drawings:

FIG. 1 is a functional block diagram illustrating the general arrangement of a map processing system according to one embodiment;

FIG. 2 is a functional block diagram illustrating a control section of a server;

FIG. 3 is a diagram illustrating how an integrated feature point is generated;

FIG. 4 is a diagram illustrating how integrated feature points are matched;

FIG. 5 is a diagram illustrating how signs are located above a road;

FIG. 6 is a diagram illustrating feature points in input maps;

FIG. 7 is a first flowchart illustrating processes performed by a microcomputer;

FIG. 8 is a second flowchart illustrating processes performed by a microcomputer; and

FIG. 9 is a diagram illustrating how the feature point that may be a mismatch is eliminated.

### DETAILED DESCRIPTION OF THE PREFERRED EMBODIMENTS

For example, JP 2002-341757 A discloses a method of setting three feature points that are common between multiple maps and correcting a triangle formed by the three feature points that have been set to increase the accuracy of the map.

The method described in JP 2002-341757 A assumes that the feature points are included in all the maps to be superimposed. In this case, a wide variety of landmarks, such as signs, signboards, compartment lines, and geometry points of road edges, may be set as the feature points, and an increase in the number of feature points proportionately increases the amount of data required for matching the feature points, thus increasing the amount of calculation. Given the circumstances, multiple feature points may be integrated to generate an integrated feature point, and integrated feature points may be matched to reduce the amount of calculation.

With the configuration in which the integrated feature points are matched, the integrated feature points are sometimes only partially recognized. If the integrated feature points are only partially recognized, the integrated feature points cannot be determined to be the integrated feature points that are common between multiple maps.

It is an object of the present disclosure to appropriately determine feature points that are common between multiple maps while appropriately reducing the amount of data required for matching the feature points, and thus appropriately processing a map.

According to one aspect of the present disclosure, a feature quantity calculating section is configured to calculate a feature quantity of a feature point included in a map. An integrated feature point generating section is configured to integrate a plurality of feature points to generate an integrated feature point. When the integrated feature point is generated, an integrated feature point matching section is configured to match integrated feature points between a plurality of maps. A feature point matching section is configured to match individual feature points between the plurality of maps. A map processing section is configured to process a map based on a matching result of the integrated feature points and a matching result of the individual feature points.

Multiple feature points are integrated to generate the integrated feature point, and integrated feature points are matched between multiple maps. This appropriately reduces the amount of data required for matching the feature points. Subsequent to matching the integrated feature points between multiple maps, individual feature points are matched between multiple maps, and the map is processed based on the matching result of the integrated feature points and the matching result of the individual feature points. Thus, the feature points that are common between multiple maps are appropriately determined. With this configuration, the feature points that are common between multiple maps are appropriately determined while appropriately reducing the amount of data required for matching the feature points, and the map is appropriately processed.

The above-mentioned and other obj ects, features, and advantages of the present disclosure will become more apparent by reference to the following description taken in conjunction with the accompanying drawings.

An embodiment will now be described with reference to the drawings. The present embodiment describes a case in which the position of an input map is corrected by superimposing a reference map on the input map while matching feature points included in the reference map with the feature points included in the input map, and the difference between the reference map and the input map is reflected in the reference map to update the reference map. The present embodiment may also be applied to a case in which an integrated input map is generated by superimposing multiple input maps while matching feature points included in the input maps. In other words, maps the feature points of which are to be matched may include the reference map and the input map or multiple input maps.

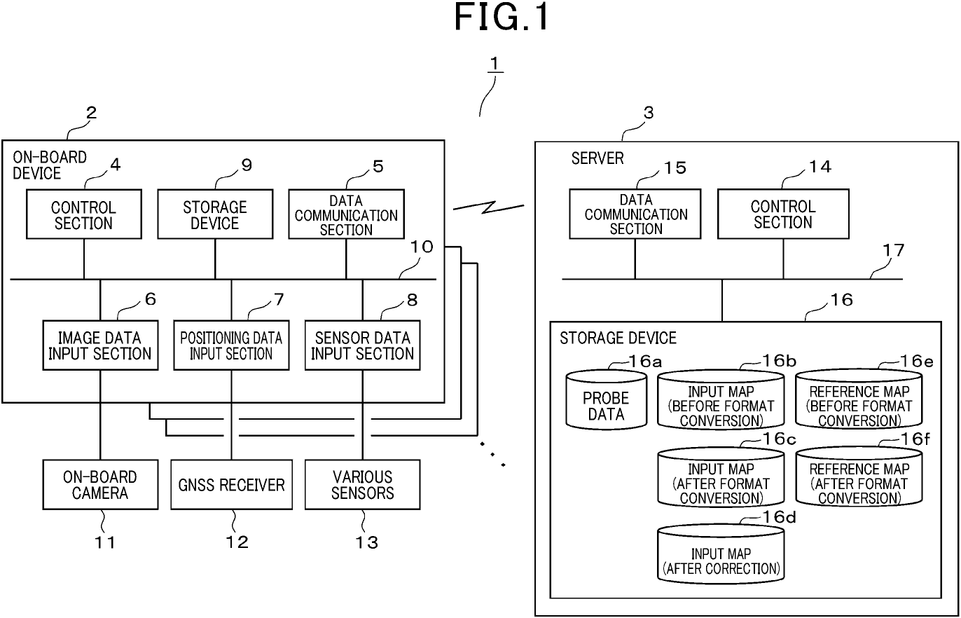

As shown in FIG. 1, the map processing system 1 includes an on-board device 2, which is mounted on a vehicle side, and a server 3, which is located on a network side. The on-board device 2 and the server 3 can communicate data with each other. The on-board device 2 and the server 3 have a multiple-to-one relationship, and the server 3 can communicate data with multiple on-board devices 2.

The on-board device 2 includes a control section 4, a data communication section 5, an image data input section 6, a positioning data input section 7, a sensor data input section 8, and a storage device 9. The functional blocks can communicate data with each other through an internal bus 10. The control section 4 is constituted by a microcomputer including a central processing unit (CPU), a read-only memory (ROM), a random-access memory (RAM), and an input/output (I/O). The microcomputer executes computer programs stored in a non-transitory tangible storage medium to perform processes corresponding to the computer programs and thus controls all operations of the on-board device 2.

The data communication section 5 controls the data communication between the on-board device 2 and the server 3. An on-board camera 11 is provided separately from the on-board device 2. The on-board camera 11 takes an image ahead of a vehicle and outputs image data that has been taken to the on-board device 2. In response to receiving the image data from the on-board camera 11, the image data input section 6 outputs the received image data to the control section 4. A global navigation satellite system (GNSS) receiver 12 is provided separately from the on-board device 2. The GNSS receiver 12 receives satellite signals transmitted from the GNSS, measures the position, and outputs the measured positioning data to the on-board device 2. In response to receiving the positioning data from the GNSS receiver 12, the positioning data input section 7 outputs the received positioning data to the control section 4. Various sensors 13 are provided separately from the on-board device 2. The sensors 13 may include, for example, a millimeter-wave radar or LiDAR (Light Detection and Ranging, Laser Imaging Detection and Ranging) and output measured sensor data to the on-board device 2. In response to receiving the sensor data from the various sensors 13, the sensor data input section 9 outputs the received sensor data to the control section 4.

The control section 4 generates probe data by associating, for example, the vehicle position, the time at which the vehicle position is measured, and the positions of landmarks, such as traffic signs or signboards above a road, and compartment lines with each other based on the image data, the positioning data, and the sensor data and stores the generated probe data in the storage device 9. It is to be noted that the probe data may include a variety of information such as the road geometry, the road characteristics, and the road width and the positional relationship.

The control section 4 reads the probe data from the storage device 9 every time (that is, every segment), for example, a predetermined time elapses or the traveling distance of the vehicle reaches a predetermined distance and transmits the probe data that has been read to the server 3 through the data communication section 5. Units of segments refer to units that partition a road or a region by predetermined units in order to manage the map. It is to be noted that the control section 4 may read the probe data in units unrelated to the units of segments and transmit the probe data that has been read to the server 3 through the data communication section 5. The units unrelated to the units of segments refer to, for example, units of regions designated by the server 3.

The server 3 includes a control section 14, a data communication section 15, and a storage device 16. The functional blocks can communicate data with each other through an internal bus 17. The control section 14 is constituted by a microcomputer including a CPU, a ROM, a RAM, and an I/O. The microcomputer executes computer programs stored in a non-transitory tangible storage medium to perform processes corresponding to the computer programs and thus controls all operations of the server 3. The computer programs executed by the microcomputer include a map processing program.

The data communication section 15 controls the data communication between the server 3 and the on-board device 2. The storage device 16 includes a probe data storage section 16a, which stores probe data, an input map storage section 16b, which stores the input map before format conversion, an input map storage section 16c, which stores the input map after format conversion, an input map storage section 16d, which stores the input map after the position has been corrected, a reference map storage section 16e, which stores the reference map before format conversion, and a reference map storage section 16f, which stores the reference map after format conversion. The input map is a map generated by a later-described input map generating section 14a based on the probe data. The reference map is, for example, a map generated by measuring on site by a map supplier. That is, when the data on site is not up to date because, for example, a new road has been opened to traffic, the input map generated from the probe data includes landmarks and compartment lines, but the reference map corresponding to this site does not include the landmarks or the compartment lines.

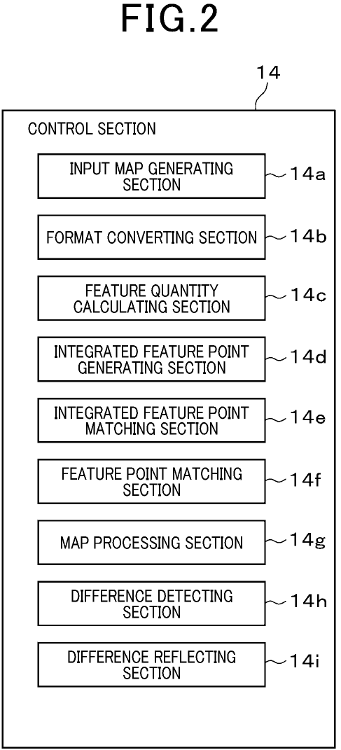

As shown in FIG. 2, the control section 14 includes an input map generating section 14a, a format converting section 14b, a feature quantity calculating section 14c, an integrated feature point generating section 14d, an integrated feature point matching section 14e, a feature point matching section 14f, a map processing section 14g, a difference detecting section 14h, and a difference reflecting section 14i. The functional blocks correspond to the processes of the map processing program executed by the microcomputer.

In response to the data communication section 15 receiving the probe data transmitted from the on-board device 2, the input map generating section 14a stores the received probe data in the probe data storage section 16a. That is, since the on-board device 2 and the server 3 have a multiple-to-one relationship, the control section 14 stores multiple sets of probe data received from multiple on-board devices 2 in the probe data storage section 16a. The input map generating section 14a reads the probe data from the probe data storage section 16a and generates an input map based on the probe data that has been read.

In this case, when the probe data transmitted from the on-board device 2 is in units of segments, and the probe data is stored in the probe data storage section 16a in the units of segments, the input map generating section 14a reads the multiple sets of probe data stored in the probe data storage section 16a unchanged and generates an input map based on the probe data that has been read. When the probe data transmitted from the on-board device 2 is in units unrelated to the units of segments, and the probe data is stored in the probe data storage section 16a in the units unrelated to the units of segments, the input map generating section 14a reads the multiple sets of probe data included in the targeted segment stored in the probe data storage section 16a and generates an input map based on the probe data that has been read.

Upon generating the input map, the input map generating section 14a stores the generated input map in the input map storage section 16b. In this case, the input map generating section 14a may store one input map in the input map storage section 16b or may generate an integrated input map by integrating multiple input maps and store the integrated input map that has been generated in the input map storage section 16b.

When integrating multiple input maps, the input map generating section 14a may use probe data transmitted from different on-board devices 2 or probe data transmitted from the same on-board device 2 at different times. The input map generating section 14a desirably acquires segments including as many feature points as possible taking into consideration that there are feature points that cannot be set as the common feature points between multiple input maps. That is, the input map generating section 14a may compare the number of feature points included in the segment with a predetermined number and set one or more segments including the predetermined number or more of feature points as an acquisition target. Meanwhile, one or more segments that do not include the predetermined number or more of feature points are not set as an acquisition target. Alternatively, the input map generating section 14a may determine the detection accuracy of the feature points and set one or more segments including a predetermined number or more of feature points the detection level of which is at a predetermined level or higher as an acquisition target. Meanwhile, one or more segments that do not include the predetermined number or more of feature points the detection level of which is at the predetermined level or higher is not set as an acquisition target.

The predetermined number and the predetermined level may be fixed values or variable values determined in accordance with, for example, the traveling position or the traveling environment of a vehicle. That is, when the vehicle is traveling in an area with a relatively small number of feature points, setting the predetermined number to a large value may possibly cause the segments that can be set as the acquisition target to become too small in number, and thus the predetermined number is desirably set to a small value. In contrast, when the vehicle is traveling in an area with a relatively large number of feature points, setting the predetermined number to a small value may possibly cause the segments that can be set as the acquisition target to become too large in number, and thus the predetermined number is desirably set to a large value. The same applies to the predetermined level, and when the detection environment is under a relatively bad environment due to the influence of, for example, weather, setting the predetermined level to a high level may possibly cause the segments that can be set as the acquisition target to become too small in number, and thus the predetermined level is desirably set to a low level. In contrast, when the detection environment is under a relatively good environment, setting the predetermined level to a low level may possibly cause the segments that can be set as the acquisition target to become too large in number, and thus the predetermined level is desirably set to a high level.

The format converting section 14b reads the reference map stored in the reference map storage section 16e, converts the data format of the reference map that has been read, and stores the reference map the data format of which has been converted in the reference map storage section 16f. The format converting section 14b reads the input map stored in the input map storage section 16b, converts the data format of the input map that has been read, and stores the input map the data format of which has been converted in the input map storage section 16c. The format converting section 14b converts the data format of the reference map and the input map and makes the data formats of the reference map and the input map the same.

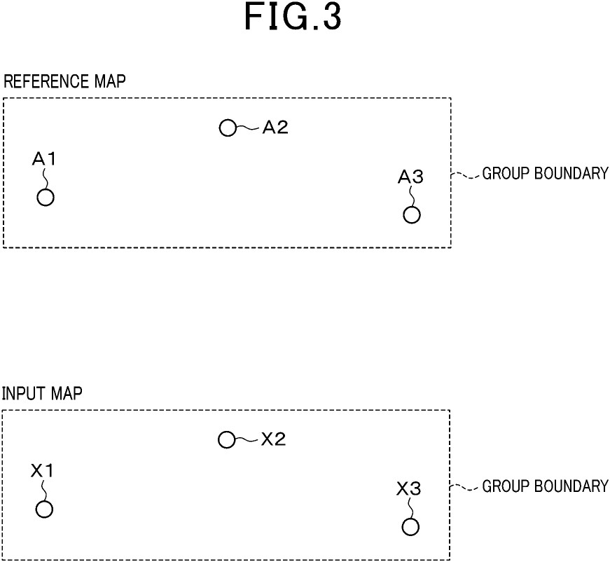

The feature quantity calculating section 14c calculates the feature quantity of the feature point. The feature quantity of the feature point refers to, for example, the type, size, position of the feature point, and the positional relationship between the feature point and a surrounding landmark. As illustrated in FIG. 3, the integrated feature point generating section 14d integrates multiple feature points in the reference map to generate an integrated feature point and integrates multiple feature points in the input map to generate an integrated feature point. The conditions for integrating multiple feature points may include, for example, (a) the distance between the feature points is 10.0 meters or less, (b) the types of the feature points match, (c) the difference in height is 1.0 meter or less, (d) the difference in width is 1.0 meter or less, and (e) the difference in orientation of a normal is 45.0 degrees or less within the boundary of a group to be integrated. The integrated feature point generating section 14d generates an integrated feature point when all the above conditions (a) to (e) are satisfied. In the example illustrated in FIG. 3, the integrated feature point generating section 14d integrates feature points A1 to A3 in the reference map on condition that the feature points A1 to A3 have satisfied all the conditions (a) to (e) to generate an integrated feature point and integrates feature points X1 to X3 in the input map on condition that the feature points X1 to X3 have satisfied all the conditions (a) to (e) to generate an integrated feature point.

In response to the integrated feature point generating section 14d generating the integrated feature points in the reference map and the input map, the integrated feature point matching section 14e matches the integrated feature points between the reference map and the input map. The integrated feature point matching section 14e matches the integrated feature points upon determining that, for example, (f) the numbers of feature points constituting the integrated feature points match, (g) the distance between the centers of gravity is 5.0 meters or less, (h) the types of the integrated feature points match, (i) the difference in height is 1.0 meter or less, (j) the difference in width is 1.0 meter or less, and (k) the difference in orientation of a normal is 45.0 degrees or less.

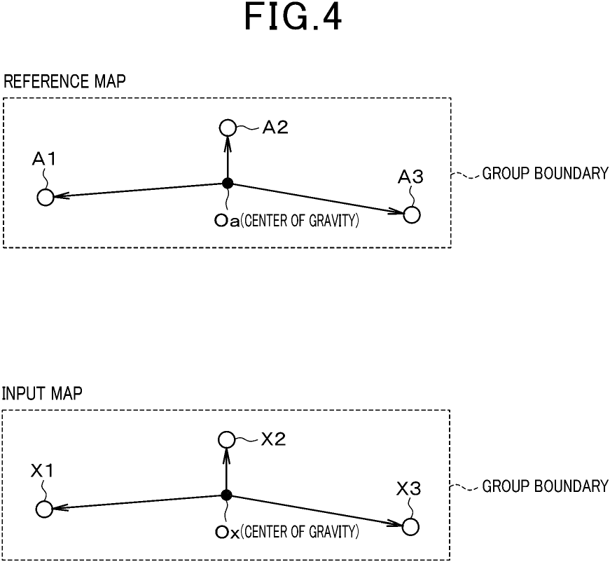

The feature point matching section 14f determines whether matching of the integrated feature points by the integrated feature point matching section 14e has succeeded. As illustrated in FIG. 4, the feature point matching section 14f determines that the matching of the integrated feature points has succeeded when the integrated feature point obtained by integrating the feature points A1 to A3 in the reference map and the integrated feature point obtained by integrating the feature points X1 to X3 in the input map have satisfied all the conditions (f) to (k).

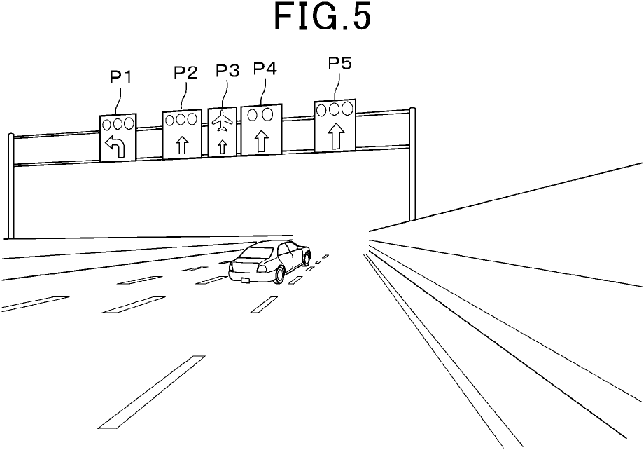

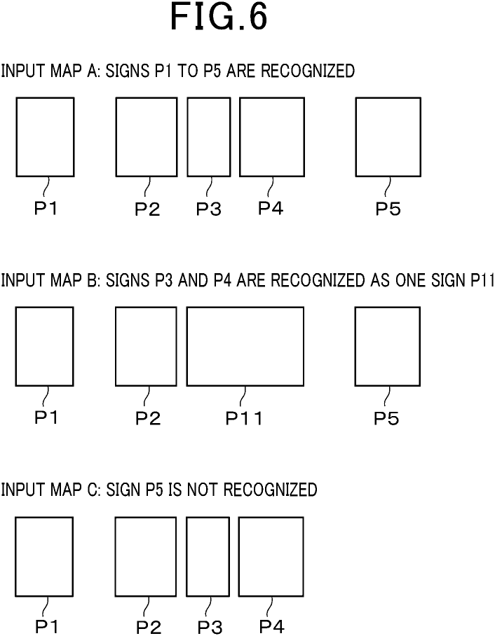

As illustrated in FIG. 5, when signs P1 to P5 are located close to each other above a road in the real world, due to the difference in clarity or the occurrence of blind spots of the on-board camera 11, the integrated feature point of the input map generated based on the probe data may differ from the integrated feature point of the reference map generated based on the signs P1 to P5 in the real world. As illustrated in FIG. 6, the signs P1 to P5 in the real world are successfully recognized in the input map A. In some cases, however, as in the input map B for example, the signs P3 and P4 among the signs P1 to P5 in the real world are recognized as one sign P11, and the sign P5 from the input map C is not recognized among the signs P1 to P5 in the real world.

In this case, when the integrated feature point obtained by integrating the feature points corresponding to the signs P1 to P5 in the real world in the reference map is matched with the integrated feature point obtained by integrating the feature points in the input map A, the feature point matching section 14f determines that the integrated feature points are successfully matched. When the integrated feature point obtained by integrating the feature points corresponding to the signs P1 to P5 in the real world in the reference map is matched with the integrated feature point obtained by integrating the feature points in the input map B or C, the feature point matching section 14f determines that the matching of the integrated feature points failed.

The feature point matching section 14f determines whether there are any integrated feature points that failed to match. Upon determining that at least one integrated feature point failed to match, the feature point matching section 14f matches the individual feature points that failed to match at least one integrated feature point between the reference map and the input map. Additionally, the feature point matching section 14f determines whether there are any individual feature points that were not used for generating the integrated feature point. Upon determining that at least one individual feature point was not used for generating the integrated feature point, the feature point matching section 14f matches at least one individual feature point that was not used for generating the integrated feature points between the reference map and the input map. The feature point matching section 14f matches the feature points upon determining that, for example, (1) the distance between the feature points is 5.0 meters or less, (m) the types of the feature points match, (n) the difference in height is 1.0 meter or less, and (o) the difference in width is 1.0 meter or less.

Based on the matching result of the integrated feature points by the integrated feature point matching section 14e and the matching result of the individual feature points by the feature point matching section 14f, the map processing section 14g corrects the position of the input map based on the reference map. That is, the map processing section 14g corrects the position of the input map by superimposing the reference map on the input map so that the feature points included in the reference map coincide with the feature points included in the input map.

Upon determining that the positions of at least four feature points coincide between the reference map and the input map, the difference detecting section 14h determines that the position of the input map has been successfully corrected and detects the difference between the reference map and the input map. In this case, the difference detecting section 14h detects static information and dynamic information in the reference map as the difference. The static information includes, for example, feature point information about the feature points, compartment line information about the compartment lines, and position information about locations. The feature point information includes, for example, position coordinates showing the position of the feature point, identifier (ID) that identifies the feature point, feature point size, feature point shape, feature point color, and feature point type. The compartment line information includes, for example, position coordinates showing the position of the compartment line, identifier (ID) that identifies the compartment line, and types such as a broken line and a solid line. The position information about locations includes, for example, GPS coordinates showing the location on a road. The dynamic information includes vehicle information about a vehicle on a road such as a vehicle speed value, blinker operation information, lane straddling, a steering angle value, a yaw rate value, and GPS coordinates. In response to the difference detecting section 14h detecting the difference between the reference map and the input map, the difference reflecting section 14i reflects the detected difference in the reference map to update the reference map.

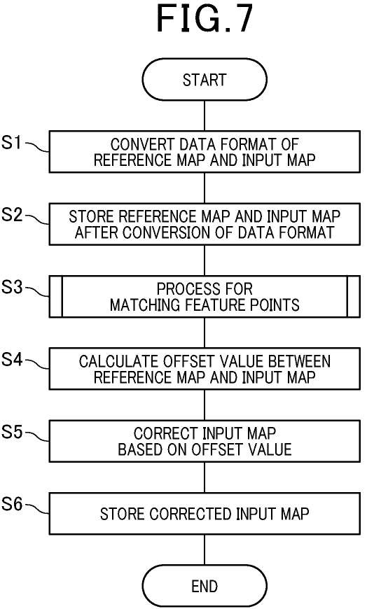

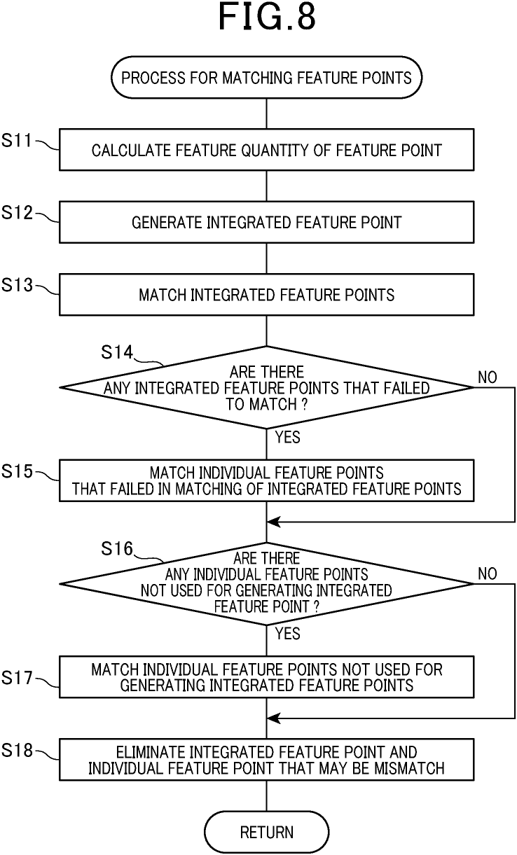

Next, the operation of the above-described configuration will be described with reference to FIGS. 7 to 9.

Upon starting the process for correcting the position of the input map, the control section 14 of the server 3 reads the reference map stored in the reference map storage section 16e, reads the input map stored in the input map storage section 16b, and converts the data formats of the reference map and the input map that have been read to make the data format the same (S1). The control section 14 stores the reference map the data format of which has been converted in the reference map storage section 16f and the input map the data format of which has been converted in the input map storage section 16c (S2).

The control section 14 proceeds to the process for matching the feature points (S3). Upon starting the process for matching the feature points, the control section 14 calculates the feature quantity of the feature points included in the reference map and the input map (S11, corresponds to a feature quantity calculating step). The control section 14 integrates multiple feature points in the reference map and the input map to generate integrated feature points (S12, corresponds to an integrated feature point generating step) and matches the integrated feature points between the reference map and the input map (S13, corresponds to an integrated feature point matching step).

The control section 14 determines whether there are any integrated feature points that failed to match (S14). When there is at least one integrated feature point that failed to match (S14:YES), the control section 14 matches the individual feature points that failed to be matched at least one integrated feature point between the reference map and the input map (S15). The control section 14 determines whether there are any individual feature points that were not used for generating the integrated feature point (S16). Upon determining that there is at least one individual feature point that was not used for generating the integrated feature point (S16: YES), the control section 14 matches at least one individual feature point that was not used for generating the integrated feature points between the reference map and the input map (S17).

The control section 14 eliminates the integrated feature point and the individual feature point that may be a mismatch among the matching results of the integrated feature points and the matching results of the individual feature points (S18) and terminates the process for matching the feature points.

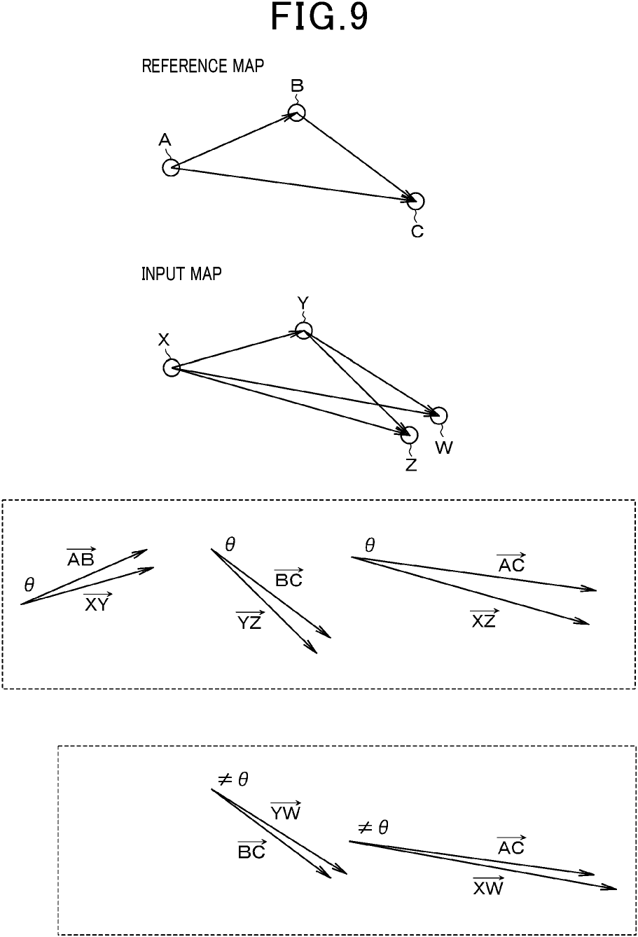

FIG. 9 illustrates the case in which the control section 14 eliminates the integrated feature point that may be a mismatch. The integrated feature points A to C are generated in the reference map, and integrated feature points W to Z are generated in the input map. The input map is displaced from the reference map by an orientation angle θ. The integrated feature points Z and W are candidates to be matched with the integrated feature point C of the reference map. When the angular difference between a vector AB and a vector XY, the angular difference between a vector BC and a vector YZ, and the angular difference between a vector AC and a vector XZ are all equal to the orientation angle θ, and neither the angular difference between the vector BC and a vector YW nor the angular difference between the vector AC and a vector XW is equal to the orientation angle θ, the control section 14 eliminates the integrated feature point W that may be a mismatch. The control section 14 eliminates the individual feature point that may be a mismatch in the same manner as when eliminating the integrated feature point as described above.

Upon terminating the process for matching the feature points, the control section 14 calculates an offset value between the reference map and the input map (S4). The control section 14 corrects the input map based on the calculated offset value (S5, corresponds to a map processing step), stores the corrected input map in the input map storage section 16d (S6), and terminates the process for correcting the position of the input map. In the following steps, the control section 14 detects the difference between the reference map and the input map and reflects the detected difference in the reference map to update the reference map.

Although the case in which the server 3 calculates the feature quantity of the feature points and integrates the feature points to generate the integrated feature points has been described above, the on-board device 2 may calculate the feature quantity of the feature points and transmit the calculated result to the server 3 or may integrate the feature points and transmit the integrated result to the server 3. That is, the functions may be shared between the server 3 and the on-board device 2 in any way.

According to the present embodiment as described above, the following operational advantages are achieved.

The server 3 integrates multiple feature points to generate the integrated feature points and matches the integrated feature points between the reference map and the input map, so that the amount of data required for matching the feature points is appropriately reduced. Subsequent to matching the integrated feature points between the reference map and the input map, the individual feature points are matched between the reference map and the input map. By processing the maps based on the matching result of the integrated feature points and the matching result of the individual feature points, the feature points that are common between the reference map and the input map are appropriately determined. Thus, feature points that are common between the reference map and the input map are appropriately determined while appropriately reducing the amount of data required for matching the feature points, and the position of the input map is appropriately corrected.

The server 3 matches the individual feature points that failed to be matched the integrated feature points between the reference map and the input map. The feature points that are common between the reference map and the input map are increased by matching the individual feature points that failed to be matched the integrated feature points. This facilitates determining the common feature points.

The server 3 matches the individual feature points that were not used for generating the integrated feature points between multiple maps. The feature points that are common between the reference map and the input map are increased by matching the individual feature points that were not used for generating the integrated feature points. This facilitates determining the common feature points.

Although the present disclosure has been described in accordance with the embodiments, it is understood that the present disclosure is not limited to the embodiments and the configurations thereof. The present disclosure embraces various modifications and deformations that come within the range of equivalency. Additionally, various combinations and forms, or other combinations and forms including only one or more additional elements, or less than all elements are included in the scope and ideas obtainable from the present disclosure.

The control section and the method disclosed in the present disclosure may be achieved by a dedicated computer constituted by a processor and a memory, which are programmed to execute one or more functions embodied by computer programs. Alternatively, the control section and the method disclosed in the present disclosure may be achieved by a dedicated computer provided by configuring a processor with one or more dedicated hardware logic circuits. Alternatively, the control section and the method disclosed in the present disclosure may be achieved by one or more dedicated computers constituted by a combination of a processor and a memory, which are programmed to execute one or more functions, and a processor constituted by one or more hardware logic circuits. Additionally, the computer program may be stored in a non-transitory, tangible computer-readable storage medium as instructions to be executed by a computer.

The server 3 has been illustrated that does not set, as the acquisition target, the segments that do not include the predetermined number or more of feature points and the segments that do not include the predetermined number or more of feature points the detection level of which is at the predetermined level or higher. However, conditions may be set for the on-board device 2 to transmit the probe data including the segments to the server 3. That is, the on-board device 2 has been illustrated that transmits the probe data to the server 3 every time, for example, the predetermined time elapses or the traveling distance of the vehicle reaches the predetermined distance. However, the on-board device 2 may determine the number of detected feature points included in the segment and transmit the probe data to the server 3 only when the number of detected feature points is greater than or equal to a predetermined number. That is, there are cases in which the number of detected feature points is not greater than or equal to the predetermined number due to, for example, the existence of a preceding vehicle. The on-board device 2 may be configured not to transmit the probe data to the server 3 when it is assumed that even if the probe data including the segment with less than the predetermined number of detected feature points is transmitted to the server 3, the server 3 will not process the probe data and will discard the probe data. Not transmitting unnecessary probe data to the server 3 from the on-board device 2 can reduce the load on the data communication.

What is claimed is:

1. A map processing system comprising:
a feature quantity calculating section configured to calculate a feature quantity of a feature point included in a map;
an integrated feature point generating section configured to integrate a plurality of feature points to generate an integrated feature point;
an integrated feature point matching section configured to match integrated feature points between a plurality of maps;
a feature point matching section configured to match individual feature points between the plurality of maps; and
a map processing section configured to process a map based on a matching result of the integrated feature points and a matching result of the individual feature points.

2. The map processing system according to claim 1, wherein
the feature point matching section is configured to match the individual feature points that failed to be matched at least one integrated feature point between the plurality of maps.

3. The map processing system according to claim 1, wherein
the feature point matching section is configured to match at least one individual feature point that was not used for generating the integrated feature points between the plurality of maps.

4. The map processing system according to claim 1, wherein
the feature quantity calculating section is configured to calculate, as the feature quantity of the feature point, at least one of a type, size, position of the feature point, and a positional relationship between the feature point and a surrounding landmark.

5. The map processing system according to claim 1, wherein
the integrated feature point matching section matches the integrated feature points based on at least one of the number of feature points constituting the integrated feature points, a distance between centers of gravity, a type of the integrated feature points, a difference in height, a difference in width, and a difference in orientation of a normal.

6. The map processing system according to claim 1, wherein
the feature point matching section matches the feature points based on at least one of a distance between features, a type of the feature points, a difference in height, and a difference in width.

7. The map processing system according to claim 1, wherein
the integrated feature point matching section is configured to match the integrated feature points between a plurality of input maps,
the feature point matching section is configured to match the individual feature points between the plurality of input maps, and
the map processing section is configured to integrate the plurality of input maps to generate an integrated input map.

8. The map processing system according to claim 1, wherein
the integrated feature point matching section is configured to match the integrated feature points between an input map and a reference map,
the feature point matching section is configured to match the individual feature points between the input map and the reference map, and
the map processing section is configured to correct a position of the input map based on the reference map.

9. A non-transitory computer-readable storage medium containing thereon a program comprising instructions configured to cause one or more processors of a map processing device to execute a map process, the instructions comprising:
calculating a feature quantity of a feature point included in a map;
integrating a plurality of feature points to generate an integrated feature point;
matching individual feature points between a plurality of maps; and
processing a map based on a matching result of integrated feature points and a matching result of the individual feature points.
